(19) United States
(12) Patent Application Publication
(10) Pub. No.: US 2009/0199808 A1
(43) Pub. Date: Aug. 13, 2009

(54) INTAKE MANIFOLD

(75) Inventors: Makoto OTSUBO, Anjo-city (JP); Naoki Osumi, Kariya-city (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP)

(21) Appl. No.: 12/360,884

(22) Filed: Jan. 28, 2009

(30) Foreign Application Priority Data
Feb. 12, 2008 (JP) 2008-30366

(51) Int. Cl. F02M 35/104

(52) U.S. Cl. 123/184.57

(57) ABSTRACT

An intake manifold includes a surge tank, a connection pipe and a membrane-type resonator. The surge tank distributes an intake air supplied through a throttle device into a combustion chamber of an engine. The connection pipe is disposed at an upstream side of the surge tank so as to be connected to the throttle device. The membrane-type resonator has a membrane for defining a chamber separated from the surge tank, and the membrane vibrates to be resonant with the intake air. The connection pipe and the chamber of the membrane-type resonator communicate with each other.

### CROSS REFERENCE TO RELATED APPLICATION

This application is based on Japanese Patent Application No. 2008-30366 filed on Feb. 12, 2008, the disclosure of which is incorporated herein by reference in its entirety.

### BACKGROUND OF THE INVENTION

1. Field of the Invention

The present invention relates to an intake manifold for sending intake air to a combustion chamber of an engine. The intake manifold is suitably mounted to a head of the engine.

2. Description of Related Art

JP-A-2007-198163 (corresponding to U.S. Pat. No. 7,350,496 B2) discloses an intake manifold 100 including a resonator 102. As shown in FIG. 4, the resonator 102 has a membrane 101 for vibrating to be resonant with an intake air. Thereby, the resonator 102 can decrease a sound of the intake air, and can increase an amount of the intake air to be sent into a combustion chamber.

The resonator 102 has a chamber 103 sealed by the membrane 101. A resonant frequency for the intake air can be set corresponding to a mechanical property of the membrane 101 and a volume of the chamber 103.

When intake air pressure or outside air pressure widely changes, a pressure difference between the chamber 103 and a surge tank 104 of the intake manifold 100 becomes large, because the chamber 103 is sealed by the membrane 101. Therefore, a load applied to the membrane 101 may become large.

In this case, because the membrane 101 needs to have high rigidity, an allowable setting range of the resonant frequency for the intake air becomes small. Therefore, the resonator 102 may not be able to be resonant with the intake air so as to decrease the sound of the intake air.

Generally, the chamber 103 and the surge tank 104 can be made to communicate with each other so as to decrease the pressure difference between the chamber 103 and the surge tank 104. However, in this case, a backfire may come into the chamber 103 from the combustion chamber through the surge tank 104. Further, unburned fuel may come into the chamber 103 from the combustion chamber, and may keep stay in the chamber 103.

### SUMMARY OF THE INVENTION

In view of the foregoing and other problems, it is an object of the present invention to provide an intake manifold.

According to an example of the present invention, an intake manifold includes a surge tank, a connection pipe and a membrane-type resonator. The surge tank distributes an intake air supplied through a throttle device into a combustion chamber of an engine. The connection pipe is disposed at an upstream side of the surge tank to be connected to the throttle device. The membrane-type resonator has a membrane for defining a chamber separated from the surge tank, and the membrane vibrates to be resonant with the intake air. The connection pipe and the chamber of the membrane-type resonator communicate with each other. Accordingly, a backfire coming from the combustion chamber can be prevented from entering the chamber of the membrane-type resonator.

### BRIEF DESCRIPTION OF THE DRAWINGS

The above and other objects, features and advantages of the present invention will become more apparent from the following detailed description made with reference to the accompanying drawings. In the drawings:

FIG. 1 is a cross-sectional view showing a structure of an intake manifold according to a first embodiment;

FIG. 2 is a cross-sectional view showing a structure of an intake manifold according to a second embodiment;

FIG. 3 is a cross-sectional view showing a structure of an intake manifold according to a third embodiment; and

FIG. 4 is a cross-sectional view showing a structure of a conventional intake manifold.

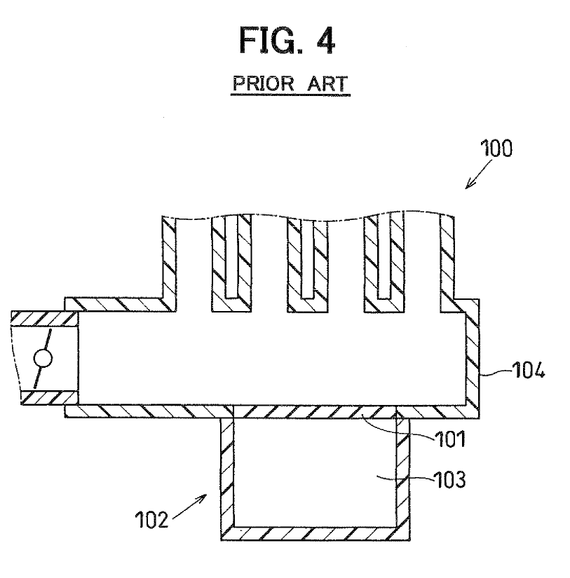

### DETAILED DESCRIPTION OF PREFERRED EMBODIMENT

### First Embodiment

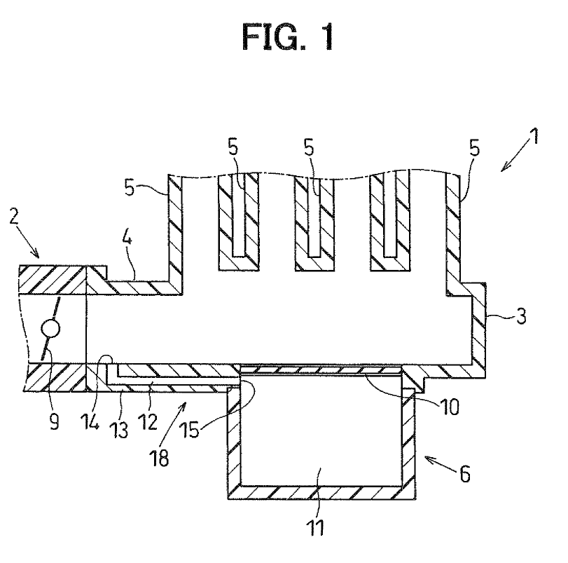

As shown in FIG. 1, an intake manifold 1 is mounted between a throttle 2 and an engine (not shown). The intake manifold 1 is configured to define a passage for supplying an intake air into the engine, and is made of resin, such as polyamide.

The intake manifold 1 includes a surge tank 3, a connection pipe 4, an intake air pipe 5, a membrane-type resonator 6. The surge tank 3 distributes the intake air supplied through the throttle 2 into a combustion chamber (not shown) of the engine. The connection pipe 4 is arranged at an upstream side of the surge tank 3 to connect the throttle 2 and the surge tank 3. The intake air pipe 5 introduces the intake air from the surge tank 3 into the combustion chamber. The membrane-type resonator 6 is resonant with the intake air to decrease a sound of the intake air. Further, the membrane-type resonator 6 increases an amount of the intake air to be sent into the combustion chamber. The intake air is supplied from the throttle 2 into the combustion chamber through the connection pipe 4, the surge tank 3 and the intake air pipe 5 in this order. For example, the throttle 2 has a butterfly valve 9 to be operated to control an opening degree of a passage for the intake air.

The membrane-type resonator 6 includes a membrane 10 for vibrating by a pressure pulsation of the intake air to be resonant with the intake air. The membrane 10 defines a chamber 11 separated from the surge tank 3. A resonant frequency for the intake air can be set corresponding to a mechanical property of the membrane 10 and a volume of the chamber 11, for example.

The intake manifold 1 further includes a communication passage 12 for making the connection pipe 4 and the chamber 11 to communicate with each other. The communication passage 12 is constructed with a wall 13 defining the connection pipe 4 and the surge tank 3. That is, the communication passage 12 is arranged inside of the wall 13, which integrally constructs the connection pipe 4 and the surge tank 3. A first end 14 of the communication passage 12 is open inside of the connection pipe 4, and a second end 15 of the communication passage 12 is open inside of the chamber 11.

A Helmholtz resonator 18 is defined by the communication passage 12 and the chamber 11. A diameter, length and so on of the communication passage 12 are set such that the resonant frequency of the Helmholtz resonator 18 for the intake air is to be equal to or smaller than a primary frequency component of a vibration generated by an engine combustion when the engine is kept idling.

For example, when a four-cylinder and four-cycle engine having an idle rotation number 660 r/min is idled, the primary frequency component is to be 22 Hz. In this case, when the chamber 11 has two-liter volume, and when the communication passage 12 has six-millimeter diameter and ten-centimeter or more length, the resonant frequency of the Helmholtz resonator 18 can be made equal to or smaller than 22 Hz.

Because the intake manifold 1 has the communication passage 12 making the connection pipe 4 and the chamber 11 to communicate with each other, a pressure in the connection pipe 4 and a pressure in the chamber 11 are approximately the same. Thus, a pressure in the surge tank 3 and the pressure in the chamber 11 are approximately the same, because the surge tank 3 communicates with the connection pipe 4. Therefore, a pressure difference is not generated between the chamber 11 and the surge tank 3. The membrane 10 does not need to have high rigidity, because there is no possibility that a large load is applied to the membrane 10, such that an allowable setting range of the resonant frequency for the intake air is not limited. Accordingly, the sound of the intake air can be definitely reduced.

Further, a backfire coming from the combustion chamber cannot reach the chamber 11 unless the backfire passes through the surge tank 3, the connection pipe 4, and the communication passage 12. Therefore, a path length for the backfire into the chamber 11 can be made long, such that the backfire is prevented from entering the chamber 11.

Further, the Helmholtz resonator 18 is defined by the communication passage 12 and the chamber 11, and the resonant frequency of the Helmholtz resonator 18 for the intake air is equal to or smaller than the primary frequency component when the engine is idled. Thereby, the Helmholtz resonator 18 is not resonant with the intake air in a practical range of the engine rotation number, even if the Helmholtz resonator 18 is formed to prevent the backfire from entering the chamber 11. Therefore, the sound of the intake air can be definitely reduced by the membrane-type resonator 6, even if the communication passage 12 is provided, because the resonance by the membrane-type resonator 6 is not inhibited by the resonance by the Helmholtz resonator 18.

### Second Embodiment

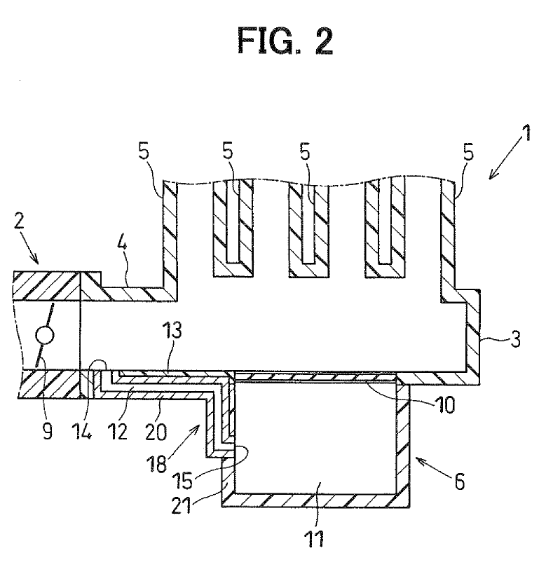

As shown in FIG. 2, a communication passage 12 is constructed with a wall made of metal. That is, the communication passage 12 is arranged inside of a tube 20 made of metal, and the tube 20 is disposed in a wall 13 defining a connection pipe 4 and a surge tank 3, and a wall 21 defining a chamber 11.

Thereby, when a backfire comes into the connection pipe 4 from a combustion chamber of an engine, the backfire is further inhibited from entering the chamber 11 by the tube 20, because the tube 20 is made of metal having fire-extinguishing effect.

### Third Embodiment

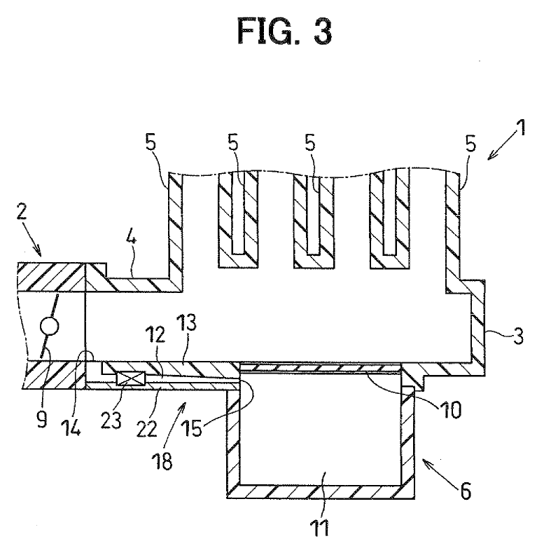

As shown in FIG. 3, a part of the wall of the communication passage 12 is made of a metal member 22. Further, a fire-extinguishing member 23 is arranged in the communication passage 12 so as to prevent the backfire from passing through the communication passage 12. For example, the fire-extinguishing member 23 is made of steel wool.

Thereby, when the backfire comes into the connection pipe 4 from a combustion chamber, the backfire is further inhibited from entering the chamber 11 by the metal member 22 and the fire-extinguishing member 23.

### (Modification)

According to the first embodiment, the communication passage 12 is constructed with the wall 13. Alternatively, a tube for defining the communication passage 12 may be arranged outside of the surge tank 3 and the connection pipe 4. In this case, the tube connects the chamber 11 and the connection pipe 4.

According to the second embodiment, the communication passage 12 is arranged in the tube 20 made of metal, and all of the wall of the communication passage 12 is made of metal. Alternatively, only a part of the wall of the communication passage 12 may be made of metal. Further, the fire-extinguishing member 23 may be arranged in the communication passage 12 of the first embodiment or the second embodiment.

Such changes and modifications are to be understood as being within the scope of the present invention as defined by the appended claims.

What is claimed is:

1. An intake manifold comprising:
a surge tank for distributing an intake air supplied through a throttle device into a combustion chamber of an engine;
a connection pipe disposed at an upstream side of the surge tank so as to be connected to the throttle device; and
a membrane-type resonator having a membrane for defining a chamber separated from the surge tank, wherein
the membrane vibrates to be resonant with the intake air, and
the connection pipe and the chamber of the membrane-type resonator communicate with each other.

2. The intake manifold according to claim 1, further comprising:
a communication passage configured to make the connection pipe and the chamber of the membrane-type resonator to communicate with each other.

3. The intake manifold according to claim 2, wherein
the communication passage and the chamber of the membrane-type resonator define a Helmholtz resonator,
the Helmholtz resonator has a resonant frequency for the intake air, and
the resonant frequency is equal to or smaller than a primary frequency component of a vibration generated by a combustion of the engine when the engine is kept idling.

4. The intake manifold according to claim 2, wherein
the communication passage is constructed with a wall, and
at least a part of the wall of the communication passage is made of a metal member.

5. The intake manifold according to claim 2, further comprising:
a fire-extinguishing member arranged in the communication passage, wherein
the fire-extinguishing member prevents fire from passing through the communication passage.

6. The intake manifold according to claim 2, wherein
the communication passage is arranged inside of a wall defining the surge tank and the connection pipe.

7. The intake manifold according to claim 2, further comprising:
a tube for defining the communication passage therein, wherein
the tube is arranged inside of a wall defining the connection pipe, the surge tank and the chamber of the membrane-type resonator.

8. The intake manifold according to claim 7, wherein
at least a part of the tube is made of metal.
